(19) United States
(12) Patent Application Publication
(10) Pub. No.: US 2026/0231259 A1
(43) Pub. Date: Aug. 6, 2026

(54) WIRELESS COMMUNICATION SYSTEM, WIRELESS COMMUNICATION METHOD, CENTRALIZED CONTROL DEVICE AND CENTRALIZED CONTROL PROGRAM

(71) Applicant: NTT, Inc., Tokyo (JP)

(72) Inventors: Junichi IWATANI, Musashino-shi, Tokyo (JP); Hirantha ABEYSEKERA, Musashino-shi, Tokyo (JP); Yusuke ASAI, Musashino-shi, Tokyo (JP); Shoko SHINOHARA, Musashino-shi, Tokyo (JP); Tomoyuki YAMADA, Musashino-shi, Tokyo (JP); Yasushi TAKATORI, Musashino-shi, Tokyo (JP)

(73) Assignee: NTT, Inc., Tokyo (JP)

(21) Appl. No.: 19/152,021

(22) PCT Filed: Feb. 2, 2023
(86) PCT No.: PCT/JP2023/003453

§ 371 Date: Jul. 30, 2025

(51) Int. Cl. H04W 76/15

(52) U.S. Cl. CPC H04W 76/15

(57) ABSTRACT

In a wireless communication system according to an embodiment, for example, a centralized control device calculates, for each MLD base station, a ratio of a total amount of transmittable traffic based on a channel and bandwidth allocated to each wireless device belonging to the MLD base station to an amount of accommodated traffic as a utility function and performs control to change at least one of the channel and bandwidth of each wireless device of the MLD base station or presence or absence of use (ON/OFF) of the wireless devices so as to maximize a total of the calculated utility functions.

### TECHNICAL FIELD

The present invention relates to a wireless communication system, a wireless communication method, a centralized control device, and a centralized control program.

### BACKGROUND ART

For example, IEEE802.11TGbe (wireless LAN) adopts a function of installing a plurality of different wireless LAN interfaces in one device to establish a plurality of transmission paths, and such a device is called a multi-link device (MLD).

Multi-link transmission (multi-link function) is, for example, wireless communication in which links are formed between an AP MLD having a plurality of base station (access point: AP) functions in one housing and an STA MLD having a plurality of wireless terminals (station: STA) in one housing.

Therefore, the multi-link transmission can improve reliability of data reception by transmitting the same data in parallel or can improve transmission efficiency by transmitting different pieces of data.

Resource allocation based on Area Throughput Optimization Policy (RATOP) is known as a method of centrally controlling radio resources such as a frequency bandwidth and a channel used by an AP of a wireless LAN to maximize effective capacity of the entire system (see, for example, Non Patent Literature 1).

In RATOP, a centralized control device grasps a state of each AP and allocates radio resources such as a frequency channel and a bandwidth to be used by each AP.

For example, RATOP defines, as an evaluation index for allocating radio resources, a ratio (utility function) of an estimated amount of transmittable traffic (amount of transmittable traffic) based on allocated radio resources (channel and bandwidth) to an estimated value of an amount of maximum traffic (amount of accommodated traffic) of each AP. The centralized control device then performs control to maximize a total value of the utility function.

### CITATION LIST

### Non Patent Literature

Non Patent Literature 1: B. A.Hirantha Sithira Abeysekera et al., “Network Controlled Frequency Channel and Bandwidth Allocation Scheme for IEEE 802.11a/n/ac Wireless LANs: RATOP”, 2014 IEEE 25th International Symposium on Personal, Indoor and Mobile Radio Communications, pp. 1041-1045

### SUMMARY OF INVENTION

### Technical Problem

As described above, a multi-link device (MLD), which includes a plurality of wireless devices in one housing and simultaneously uses a plurality of links, has been considered as a form of a wireless communication system. However, in the method of centrally controlling radio resources such as RATOP, control in which the MLD is assumed has not been sufficiently examined.

An object of the present invention is to provide a wireless communication system, a wireless communication method, a centralized control device, and a centralized control program capable of centrally controlling a system including a base station capable of performing multi-link transmission so as to optimize allocation of radio resources.

### Solution to Problem

A wireless communication system according to an embodiment of the present invention is a wireless communication system including one or more MLD base stations that include a plurality of wireless devices and are capable of performing multi-link transmission with respect to one or more wireless terminals including an MLD wireless terminal including a plurality of wireless devices that uses different frequency bands and a centralized control device that centrally controls each of the MLD base stations, in which the centralized control device includes a utility function calculation unit that calculates, for each of the MLD base stations, a ratio of a total amount of transmittable traffic based on a channel and bandwidth allocated to each of the wireless devices belonging to the MLD base station to an amount of accommodated traffic as a utility function, and a change control unit that performs control to change at least one of the channel and bandwidth of each of the wireless devices of the MLD base station or presence or absence of use of the wireless devices so as to maximize a total of the utility functions calculated by the utility function calculation unit.

A wireless communication method according to an embodiment of the present invention is a wireless communication method that centrally controls one or more MLD base stations that include a plurality of wireless devices and are capable of performing multi-link transmission with respect to one or more wireless terminals including an MLD wireless terminal including a plurality of wireless devices that uses different frequency bands, the wireless communication method including: a utility function calculation step of calculating, for each of the wireless devices of the MLD base stations, a ratio of a total amount of transmittable traffic based on a channel and bandwidth allocated to each of the wireless devices belonging to the MLD base station to an amount of accommodated traffic as a utility function, and a change control step of performing control to change at least one of the channel and bandwidth of each of the wireless devices of the MLD base station or presence or absence of use of the wireless devices so as to maximize a total of the utility functions calculated in the utility function calculation step.

A centralized control device according to an embodiment of the present invention is a centralized control device that centrally controls one or more MLD base stations that include a plurality of wireless devices and are capable of performing multi-link transmission with respect to one or more wireless terminals including an MLD wireless terminal including a plurality of wireless devices that uses different frequency bands, the centralized control device including: a utility function calculation unit that calculates, for each of the MLD base stations, a ratio of a total amount of transmittable traffic based on a channel and bandwidth allocated to each of the wireless devices belonging to the MLD base station to an amount of accommodated traffic as a utility function; and a change control unit that performs control to change at least one of the channel and bandwidth of each of the wireless devices of the MLD base station or presence or absence of use of the wireless devices so as to maximize a total of the utility functions calculated by the utility function calculation unit.

### Advantageous Effects of Invention

According to the present invention, it is possible to centrally control a system including a base station capable of performing multi-link transmission so as to optimize allocation of radio resources.

### BRIEF DESCRIPTION OF DRAWINGS

FIG. 1 shows a configuration example of a wireless communication system according to an embodiment.

FIG. 2 is a functional block diagram showing functions of a centralized control device according to an embodiment.

FIG. 3 shows an operation mode of the wireless communication system according to the embodiment.

FIG. 4 shows a first example of a RATOP algorithm executed by the centralized control device according to the embodiment.

FIG. 5 shows a second example of the RATOP algorithm executed by the centralized control device according to the embodiment.

FIG. 6 shows a third example of the RATOP algorithm executed by the centralized control device according to the embodiment.

FIG. 7 is a flowchart showing an operation example of the wireless communication system according to the embodiment.

FIG. 8 shows a hardware configuration of the centralized control device according to the embodiment.

FIG. 9 shows a configuration example of a wireless communication system that does not include a multi-link device.

FIG. 10 shows a specific example of a RATOP algorithm executed by a centralized control device.

### DESCRIPTION OF EMBODIMENTS

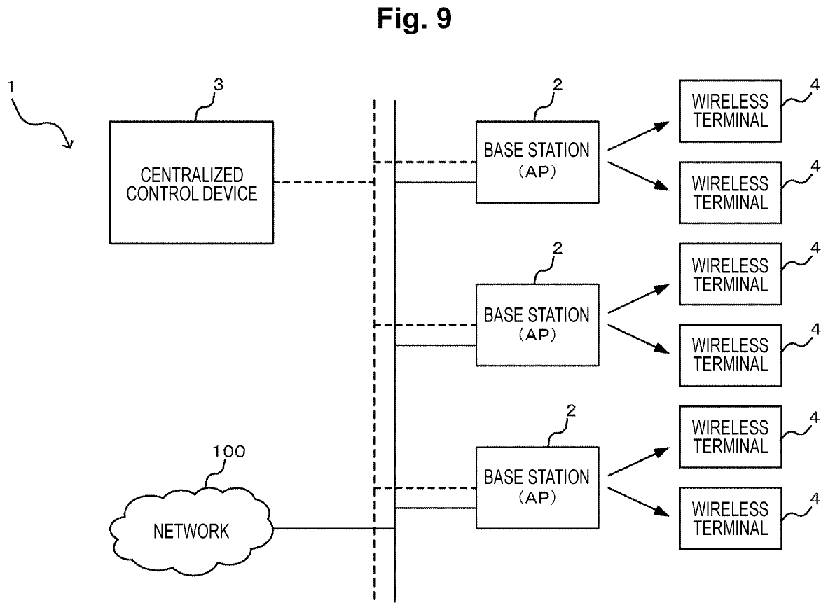

First, the background of the present invention will be described. FIG. 9 shows a configuration example of a wireless communication system 1 that does not include a multi-link device. The wireless communication system 1 is, for example, a wireless LAN system that does not include an AP MLD (MLD base station) or a STA MLD (MLD wireless terminal), and the above RATOP is applied thereto.

As shown in FIG. 9, the wireless communication system 1 includes, for example, a plurality of base stations 2, a centralized control device 3, and a plurality of wireless terminals 4 connected to a network 100. Each of the base stations 2 is centrally controlled by the centralized control device 3 to accommodate a plurality of wireless terminals 4. Hereinafter, the base station may also be referred to as an AP.

The centralized control device 3 performs RATOP control on the plurality of base stations 2. At this time, an index of the control is assumed to be a utility function U (=corresponding to a degree of satisfaction) in Equation (1) below.

$$\begin{matrix}[ Math . 1 ] & \\ {U}_{( b , c )}^{( a )} = \frac{\begin{matrix}Amount of transmittable traffic when using \\ bandwidth b and channel c {Φ}_{( b , c , K )}^{( a )}\end{matrix}}{Amount of accommodated traffic {θ}^{( a )}} & ( 1 )\end{matrix}$$

a: identifier of AP
b: bandwidth
c: channel (primary channel)
R: data rate (MCS)

The amount of transmittable traffic of the AP (a) depends on a channel usage state or the like of another AP. The amount of accommodated traffic (which depends on an amount of generated data) is, for example, a maximum traffic estimation value of the AP (a) expressed by Equation (2) below.

$$\begin{matrix}[ Math . 2 ] & \\ Maximum traffic estimation value of AP ( a ) ( = min \{ amount of generated data , amount of transmittable \\ traffic when there is no another AP in surroundings \} ) & ( 2 )\end{matrix}$$

At this time, the maximum traffic estimation value may be assumed to be the amount of accommodated traffic per wireless terminal×the number of assumed wireless terminals. The centralized control device 3 then performs processing of maximizing a total ΣU of the utility functions U according to the following algorithm.

### RATOP Algorithm:

(A): The centralized control device 3 “temporarily allocates” a channel and bandwidth to be used by each AP according to a predetermined rule.
(B): The centralized control device 3 calculates the total ΣU of the utility functions U of the respective APs in the above case (A).
(C): The centralized control device 3 reallocates the channel and bandwidth to an AP having a low utility function U and performs control so as not to decrease ΣU. The centralized control device 3 then repeats the above (C) within a predetermined condition range.

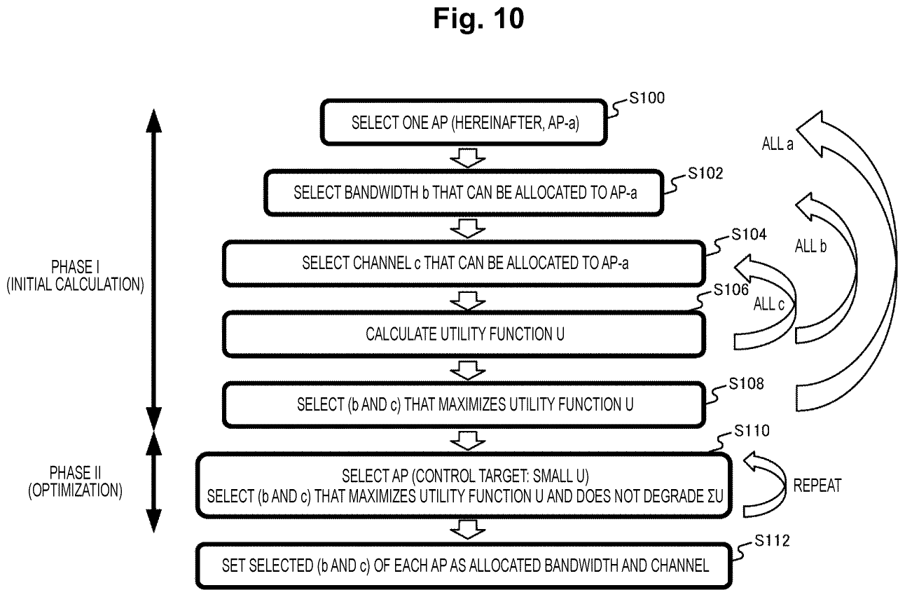

FIG. 10 shows a specific example of the RATOP algorithm executed by the centralized control device 3. As shown in FIG. 10, the centralized control device 3 performs processing of a phase I (initial calculation) and a phase II (optimization).

In the phase I, the centralized control device 3 selects one AP as AP-a (S100), selects the bandwidth b that can be allocated to AP-a (S102), selects the channel (primary channel) c that can be allocated to AP-a (S104), and calculates the utility function U of AP-a (S106).

The centralized control device 3 then executes the processing in S104 and the processing in S106 for all the channels c and further repeats the processing for all the bandwidths b.

Next, the centralized control device 3 selects a combination (b and c) that maximizes the utility function U (S108) and repeats the processing for all the APs.

In the phase II, for example, after selecting an AP having a small utility function U, the centralized control device 3 repeats the processing of selecting a combination (parameter) of (b and c) that maximizes the utility function U and does not degrade the total ΣU of the utility functions U (S110).

The centralized control device 3 then sets the selected combination (b and c) of each AP as a controlled allocated bandwidth and channel.

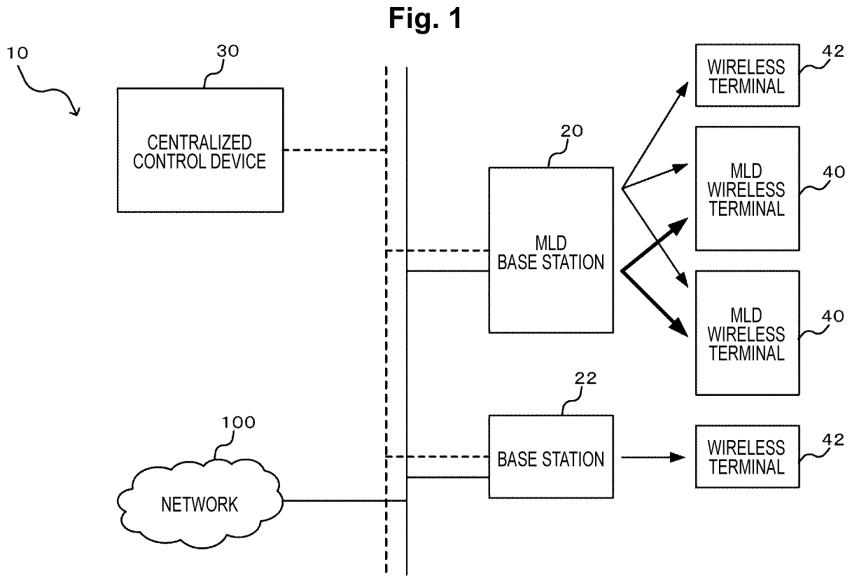

Next, a wireless communication system 10 according to the embodiment will be described. FIG. 1 shows a configuration example of the wireless communication system 10 according to the embodiment. The wireless communication system 10 is a wireless LAN system including an AP MLD (MLD base station) and an STA MLD (MLD wireless terminal), and the above RATOP is applied to the MLDs.

As shown in FIG. 1, the wireless communication system 10 includes, for example, an MLD base station 20, a base station 22, a centralized control device 30, a plurality of MLD wireless terminals 40, and a plurality of wireless terminals 42 connected to a network 100.

Here, the wireless communication system 10 includes the MLD base station 20 having a multi-link function and the base station 22 not having the multi-link function as a base station that accommodates wireless terminals. The wireless communication system 10 also includes the MLD wireless terminals 40 having the multi-link function and the wireless terminals 42 not having the multi-link function as a wireless terminal.

The centralized control device 30 centrally controls the MLD base station 20 and the base station 22. The MLD base station 20 accommodates the plurality of MLD wireless terminals 40 and the wireless terminal 42 under the control of the centralized control device 30. The base station 22 accommodates the wireless terminal 42 under the control of the centralized control device 30.

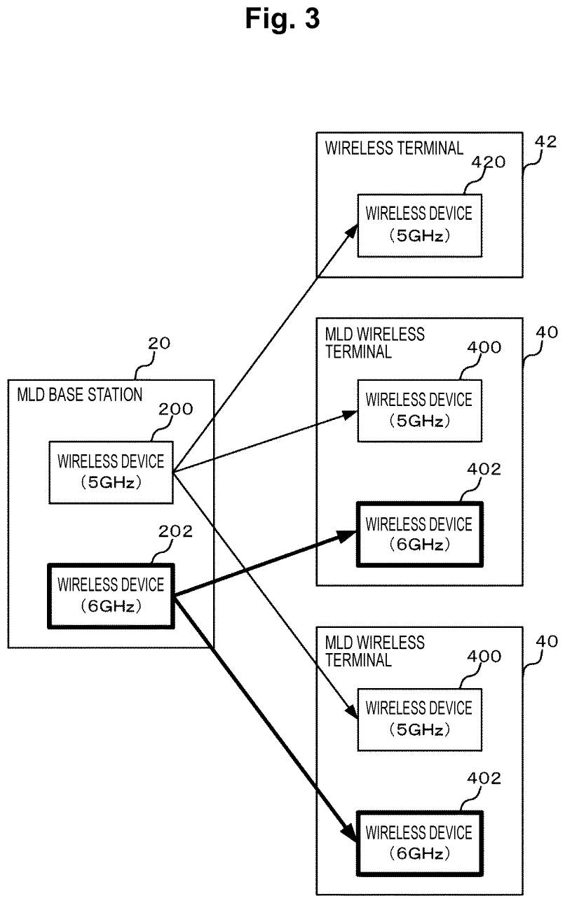

That is, the wireless communication system 10 includes one or more MLD base stations 20 including a plurality of wireless devices (see FIG. 3) and capable of performing multi-link transmission with respect to one or more wireless terminals including the MLD wireless terminal 40 including a plurality of wireless devices (see FIG. 3) that uses different frequency bands for wireless communication and the centralized control device 30 that centrally controls the MLD base stations 20 and the base station 22.

When traffic increases in some of the plurality of wireless devices of the MLD base station 20, traffic of the other wireless devices decreases, and thus it is advantageous to aggregate traffic to an optimal link in some cases. In this case, the wireless communication system 10 can also reduce power consumption.

Therefore, in optimization of RATOP, the wireless communication system 10 derives an optimal pattern also in consideration of a combination of ON/OFF of links of each wireless device. The wireless communication system 10 may derive the optimal pattern also in consideration of the combination of ON/OFF in the initial calculation phase or may derive the optimal pattern also in consideration of the combination of ON/OFF in the optimization phase.

In order to suppress power consumption to a certain value or less, the wireless communication system 10 may set an upper limit of the number of wireless devices to be used and optimize ON/OFF of the links such that the number of wireless devices does not exceed the upper limit. The wireless communication system 10 may use the number of wireless devices to be used in addition to the total of the utility functions as an evaluation index in the optimization phase.

Next, functions of the centralized control device 30 will be described more specifically.

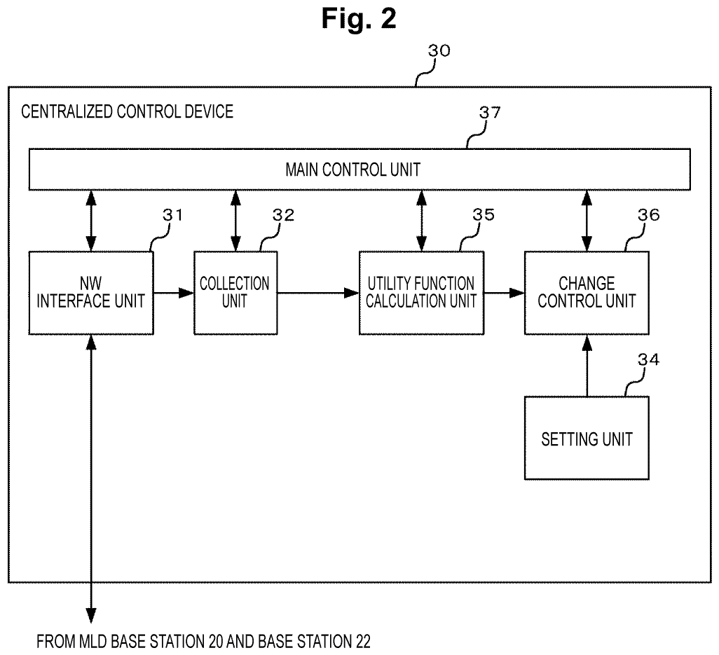

FIG. 2 is a functional block diagram showing the functions of the centralized control device 30 according to the embodiment. As shown in FIG. 2, the centralized control device 30 includes, for example, an NW interface unit 31, a collection unit 32, a determination unit 33, a setting unit 34, a utility function calculation unit 35, a change control unit 36, and a main control unit 37.

The NW interface unit 31 transmits and receives control information to and from the MLD base station 20 and the base station 22.

The collection unit 32 collects information regarding the MLD base station 20 and the base station 22 via the NW interface unit 31 and outputs the information to the determination unit 33 and the utility function calculation unit 35. For example, the collection unit 32 collects information (e.g. traffic information) regarding the MLD wireless terminal 40 and the wireless terminal 42 as a part of the information regarding the MLD base station 20 and the base station 22.

The setting unit 34 sets the upper limit of the total number of wireless devices to be used as a whole to, for example, the change control unit 36.

The utility function calculation unit 35 calculates, for each MLD base station 20, a ratio of a total amount of transmittable traffic based on a channel and bandwidth allocated to each wireless device belonging thereto to an amount of accommodated traffic as a utility function and outputs the utility function to the change control unit 36.

The change control unit 36 performs control to change at least one of the channel and bandwidth of each wireless device of the MLD base station 20 and the presence or absence of use of the wireless device so as to maximize the total of the utility functions calculated by the utility function calculation unit 35.

In a case where there are combinations of the presence or absence of use of wireless devices in a plurality of different MLD base stations 20 having the same total of the utility functions calculated by the utility function calculation unit 35, the change control unit 36 performs control to prioritize a combination of the presence or absence of use of wireless devices with a smaller total number of wireless devices of the MLD base station 20.

The main control unit 37 controls each unit of the centralized control device 30.

Next, an operation mode of the wireless communication system 10 will be described by using a specific example of the MLD base station 20, the plurality of MLD wireless terminals 40, and the wireless terminal 42. Also here, in the wireless communication system 10, the centralized control device 30 calculates the utility function U for each MLD base station 20 and centrally controls the MLD base station 20 and the base station 22.

FIG. 3 shows the operation mode of the wireless communication system 10 according to the embodiment. Here, the MLD base station 20 includes a wireless device 200 that performs wireless communication by using the 5 GHz band and a wireless device 202 that performs wireless communication by using the 6 GHz band.

The MLD wireless terminal 40 includes a wireless device 400 that performs wireless communication by using the 5 GHz band and a wireless device 402 that performs wireless communication by using the 6 GHz band. The wireless terminal 42 includes one wireless device 420 that performs wireless communication by using the 5 GHz band.

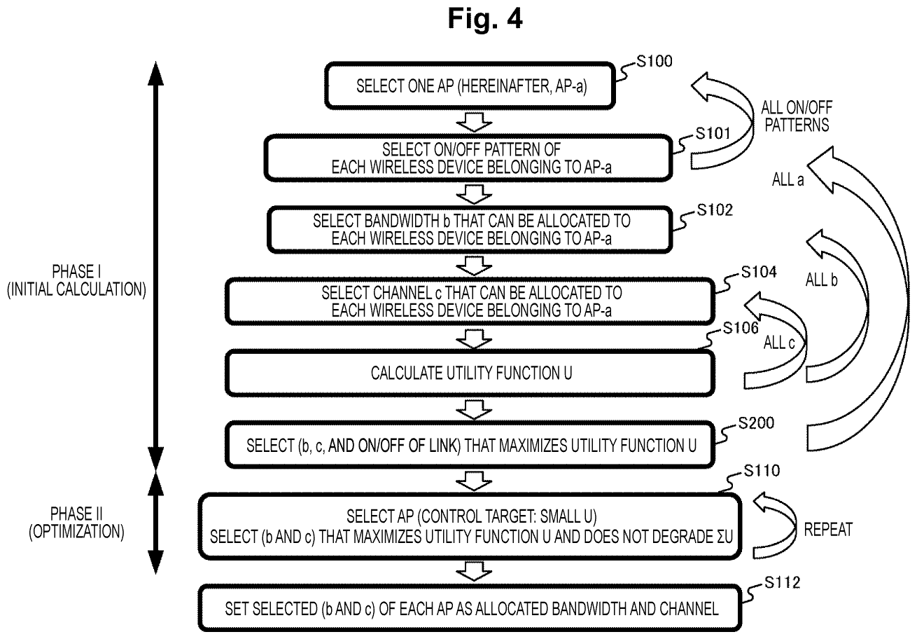

Next, a first example of a RATOP algorithm executed by the centralized control device 30 will be described. FIG. 4 shows the first example of the RATOP algorithm executed by the centralized control device 30 according to the embodiment. Hereinafter, substantially the same pieces of processing as those in the algorithm of FIG. 10 are denoted by the same reference signs.

As shown in FIG. 4, in the first example of the RATOP algorithm executed by the centralized control device 30, the centralized control device 30 selects a combination of (b and c of each wireless device in the MLD base station 20 and ON/OFF of the wireless device) that maximizes the utility function U by processing in S200 in the initial calculation phase I and repeats the processing for all the MLD base stations. The utility function is calculated for each MLD base station, and the amount of transmittable traffic of the MLD base station is a total amount of transmittable traffic of the wireless devices.

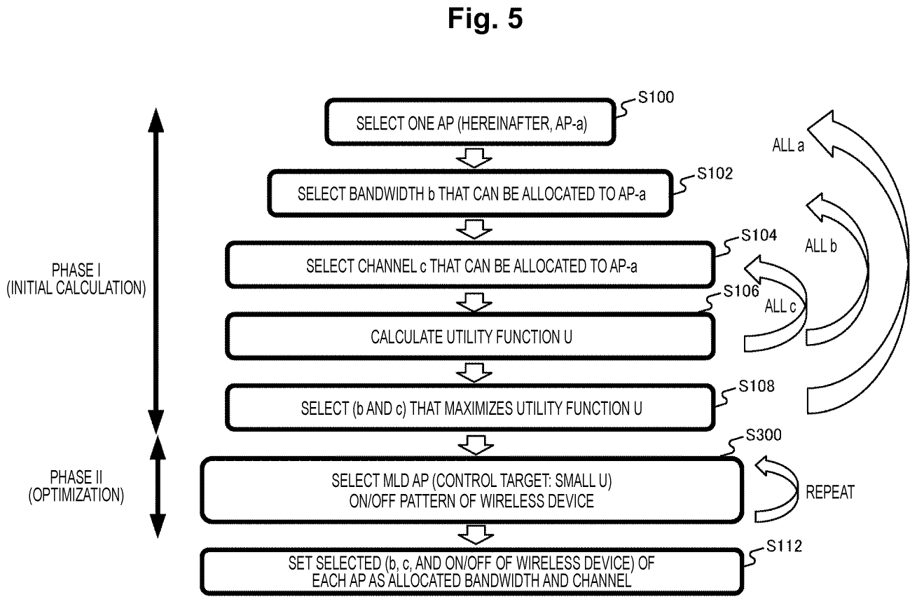

FIG. 5 shows a second example of the RATOP algorithm executed by the centralized control device 30 according to the embodiment.

As shown in FIG. 5, in the second example of the RATOP algorithm executed by the centralized control device 30, the centralized control device 30 repeats processing of selecting, for example, an MLD base station having a small utility function U by processing in S300 in the optimization phase II and then selecting a combination (parameter) of (b and c of each wireless device in the MLD base station and ON/OFF of the wireless device) that maximizes the utility function U and does not degrade the total ΣU of the utility functions U.

For example, the centralized control device 30 controls (updates) the MLD base stations 20 (including the plurality of wireless devices) in order from the MLD base station having the worst condition in consideration of a combination pattern of ON/OFF of links of each wireless device belonging thereto.

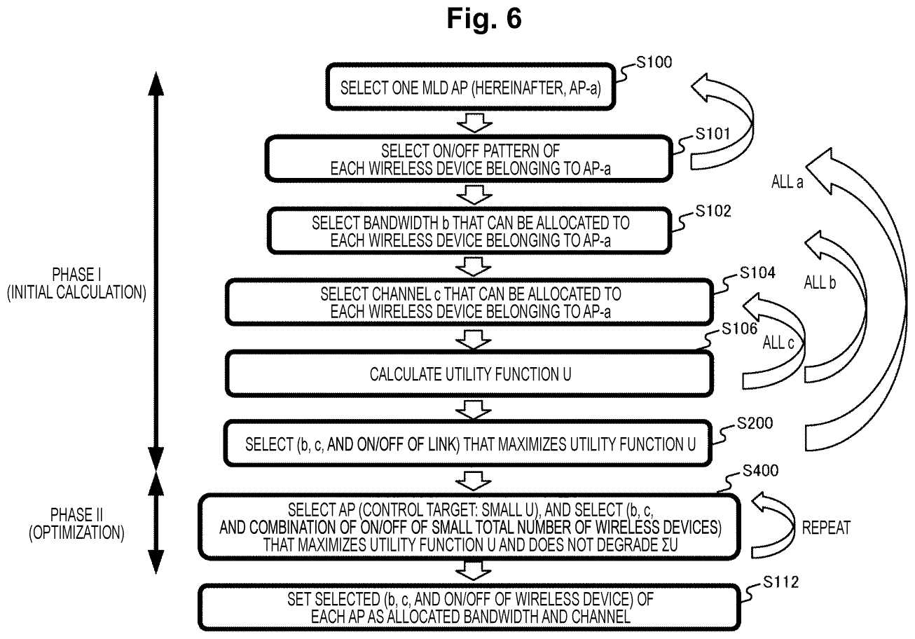

FIG. 6 shows a third example of the RATOP algorithm executed by the centralized control device 30 according to the embodiment. Hereinafter, substantially the same pieces of processing as those in the algorithm of FIG. 4 are denoted by the same reference signs.

As shown in FIG. 6, in the third example of the RATOP algorithm executed by the centralized control device 30, the centralized control device 30 first executes the processing in S200 in the initial calculation phase I. Thereafter, the centralized control device 30 repeats processing of selecting, for example, an MLD base station having a small utility function U by processing in S400 in the optimization phase II and then selecting a combination (parameter) of (b and c of each wireless device in the MLD base station and ON/OFF of the wireless device) that maximizes the utility function U, has a small total number of devices in the MLD to be used, and does not degrade the total ΣU of the utility functions U.

That is, the centralized control device 30 sets the upper limit of the number of wireless devices to be used in the entire wireless communication system 10 and includes the total number of wireless devices to be used (smaller number is desirable) in addition to the total (ΣU) of the utility functions as an evaluation index in the optimization phase II.

The centralized control device 30 may perform control by combining the second example and the third example of the RATOP algorithm.

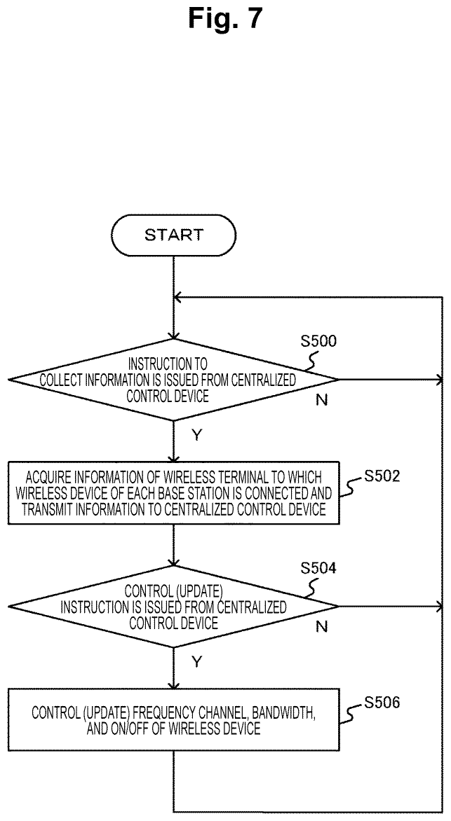

FIG. 7 is a flowchart showing an operation example of the wireless communication system 10 according to the embodiment. First, the MLD base station 20 and the base station 22 determine whether or not an instruction to collect information is issued from the centralized control device 30 (S500). If the instruction is issued (S500: Yes), the processing proceeds to S502, and if the instruction is not issued (S500: No), the processing in S500 is repeated.

In step 502 (S502), the MLD base station 20 and the base station 22 acquire information of a wireless terminal to which the wireless device thereof is connected and transmit the information to the centralized control device 30. For example, the MLD base station 20 acquires information such as the number of wireless terminals connected to each of the wireless devices 200 and 202, whether or not the wireless terminal is an MLD wireless terminal, and a frequency band.

In step 504 (S504), the MLD base station 20 and the base station 22 determine whether or not a control instruction to update the bandwidth b and the channel c of the wireless device thereof and ON/OFF of the wireless device (or a control instruction to update distribution of the traffic) is issued from the centralized control device 30. When determining that the control instruction is issued (S504: Yes), the MLD base station 20 and the base station 22 proceed to the processing in S506, and when determining that the control instruction is not issued (S504: No), the MLD base station 20 and the base station 22 return to the processing in S500.

In step 506 (S506), the MLD base station 20 and the base station 22 perform change control to change the bandwidth b, the channel c, and ON/OFF of the wireless device (or control to update the distribution of the traffic) and return to the processing in S500.

As described above, because the wireless communication system 10 according to the embodiment calculates the utility function for each MLD base station 20, it is possible to centrally control a system including a base station capable of performing multi-link transmission so as to optimize allocation of the radio resources.

Some or all of the functions of the centralized control device 30 may be configured with hardware such as a programmable logic device (PLD) or a field programmable gate array (FPGA) or may be configured as a program executed by a processor such as a CPU.

For example, the centralized control device 30 can be implemented by using a computer and a program, and the program can be recorded in a storage medium or be provided through a network.

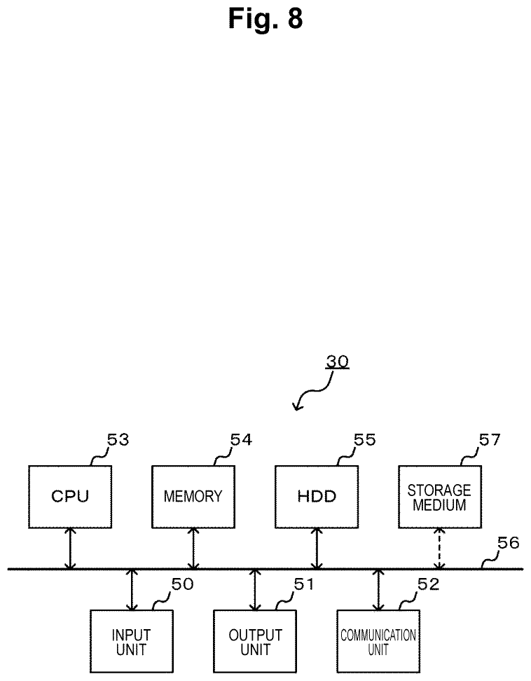

FIG. 8 shows a hardware configuration of the centralized control device 30 according to the embodiment. As shown in FIG. 8, the centralized control device 30 has a function as a computer in which an input unit 50, an output unit 51, a communication unit 52, a CPU 53, a memory 54, and an HDD 55 are connected via a bus 56. The centralized control device 30 can input and output data to and from a computer-readable storage medium 57.

The input unit 50 is, for example, a keyboard and a mouse. The output unit 51 is, for example, a display device such as a display.

The communication unit 52 is a communication interface that communicates with a wireless communication device to be controlled.

The CPU 53 controls each unit of the centralized control device 30 and performs predetermined processing and the like. The memory 54 and the HDD 55 store data and the like.

The storage medium 57 can store, for example, a program for executing the functions of the centralized control device 30. An architecture configuring the centralized control device 30 is not limited to the example in FIG. 8.

### REFERENCE SIGNS LIST

1, 10 Wireless communication system
20 MLD base station
2, 22 Base station
3, 30 Centralized control device
31 NW interface unit
32 Collection unit
33 Determination unit
34 Setting unit
35 Utility function calculation unit
36 Change control unit
37 Main control unit
40 MLD wireless terminal
4, 42 Wireless terminal
50 Input unit
51 Output unit
52 Communication unit
53 CPU
54 Memory
55 HDD
56 Bus
57 Storage medium
100 Network
200, 202, 220, 400, 402, 420 Wireless device

1. A wireless communication system including one or more MLD base stations that include a plurality of wireless devices and are capable of performing multi-link transmission with respect to one or more wireless terminals including an MILD wireless terminal including a plurality of wireless devices that uses different frequency bands and a centralized control device that centrally controls each of the MILD base stations, wherein
the centralized control device includes
utility function calculation circuitry configured to calculate, for each of the MILD base stations, a ratio of a total amount of transmittable traffic based on a channel and bandwidth allocated to each of the wireless devices belonging to the MILD base station to an amount of accommodated traffic as a utility function, and
change control circuitry configured to perform control to change at least one of the channel and bandwidth of each of the wireless devices of the MILD base station or presence or absence of use of the wireless devices so as to maximize a total of the utility functions calculated by the utility function calculation circuitry.

2. The wireless communication system according to claim 1, comprising
setting circuitry configured to set an upper limit of a total number of wireless devices that simultaneously perform wireless communication in the MLD base station to the change control circuitry.

3. The wireless communication system according to claim 1, wherein
in a case where there are combinations of presence or absence of use of wireless devices in a plurality of different MLD base stations having the same total of the utility functions calculated by the utility function calculation circuitry, the change control circuitry perform control to prioritize a combination of presence or absence of use of wireless devices with a smaller total number of wireless devices in the MILD base station.

4. A wireless communication method that centrally controls one or more MILD base stations that include a plurality of wireless devices and are capable of performing multi-link transmission with respect to one or more wireless terminals including an MILD wireless terminal including a plurality of wireless devices that uses different frequency bands, the wireless communication method comprising:
calculating, for each of the MILD base stations, a ratio of a total amount of transmittable traffic based on a channel and bandwidth allocated to each of the wireless devices belonging to the MILD base station to an amount of accommodated traffic as a utility function, and
performing control to change at least one of the channel and bandwidth of each of the wireless devices of the MILD base station or presence or absence of use of the wireless devices so as to maximize a total of the utility functions calculated in the calculating.

5. A centralized control device that centrally controls one or more MLD base stations that include a plurality of wireless devices and are capable of performing multi-link transmission with respect to one or more wireless terminals including an MLD wireless terminal including a plurality of wireless devices that uses different frequency bands, the centralized control device comprising:
utility function calculation circuitry configured to calculate, for each of the MLD base stations, a ratio of a total amount of transmittable traffic based on a channel and bandwidth allocated to each of the wireless devices belonging to the MLD base station to an amount of accommodated traffic as a utility function; and
change control circuitry configured to perform control to change at least one of the channel and bandwidth of each of the wireless devices of the MILD base station or presence or absence of use of the wireless devices so as to maximize a total of the utility functions calculated by the utility function calculation circuitry.

6. A non-transitory computer-readable storage medium storing a centralized control program for causing a computer to function as each circuitry of the centralized control device according to claim 5.
